(19) United States
(12) Patent Application Publication
(10) Pub. No.: US 2015/0100446 A1
(43) Pub. Date: Apr. 9, 2015

(54) APPARATUS, AND ASSOCIATED METHOD, FOR PURCHASING COMMERCE ITEM USING BID SOLICITATION

(71) Applicant: Rami Alfalahi, Oxshott (GB)

(72) Inventor: Rami Alfalahi, Oxshott (GB)

(21) Appl. No.: 14/507,168

(22) Filed: Oct. 6, 2014

Related U.S. Application Data
(60) Provisional application No. 61/888,884, filed on Oct. 9, 2013.

(51) Int. Cl. G06Q 30/06; G06Q 30/08

(52) U.S. Cl. CPC G06Q 30/0605; G06Q 30/08
USPC 705/26.2

(57) ABSTRACT

An apparatus, and an associated method, facilitates purchase of a commerce item by a prospective buyer. The prospective buyer submits information associated with a commerce item that the prospective buyer desires to sell. The information is posted, available to prospective sellers of the commerce item. The prospective sellers submit bids, and the prospective buyer selects from amongst the submitted bids to purchase the commerce item.

The present disclosure relates generally to a manner by which to provide a buyer of a product, service, or other commerce item with seller-submitted bids to sell the commerce item to the buyer. More particularly, the present disclosure relates to an apparatus, and an associated method, by which to provide for notification to prospective sellers of buyer interest to purchase a commerce item and to solicit, and to receive bids, from prospective sellers of the commerce item.

A buyer posts the identity of the commerce item, solicits bids for sale of the commerce item, and makes selection from amongst competing offers to sell the commerce item. When implemented online, the buyer is able to obtain offers from any seller willing to compete to sell the commerce item. In one implementation, Bidding is open, viz., a seller is able to view bids made by other prospective sellers.

### BACKGROUND

Throughout history, commerce has provided for the exchange of goods and services. A buyer desiring to obtain a good or service purchases the good or service from a seller that sells the good or service. Rules relating to commerce and conflicts arising out of commerce have been developed in different societies throughout history to facilitate commerce between buyers and sellers, to regulate commerce, and to resolve conflicts arising out of problems in transactions between the buying and selling parties.

Commerce between buyers and sellers is often times local in nature, i.e., resulting face-to-face interaction between a buyer and a seller. With technological advancements, a transaction in commerce increasingly need not be local in nature. Written agreements forming contracts between buying and selling parties can be communicated by postal or courier services even though the buyer and seller are separated by large distances. The electronic communications provide for telephonic and other electrical transmission of information relating to goods and services available for sale and buyers of goods and services. Significant portions of the transactions of commerce in modern society are carried out in this manner.

Development, deployment, and widespread usage of the internet have further facilitated the reach and convenience of commerce between widely-dispersed buyers and sellers. Ebay™, e.g., provides sellers of commerce items with the ability to solicit bids from prospective buyers of the commerce item, such as in an auction process period, a much larger pool of prospective buyers is available to the seller of the commerce item.

In significant part, the new schemes that facilitate commerce are directed towards the sellers of the commerce items. There remains a need to provide buyers with larger pools of prospective sellers of goods and services to provide a buyer with advantages that greater competition between sellers would permit.

It is in light of this background information related to commerce that the significant improvements of the present disclosure have evolved.

### BRIEF DESCRIPTION OF THE DRAWINGS

FIG. 1 illustrates a functional block diagram of a communication system in which an implementation of the present disclosure is implemented.

FIG. 2 illustrates a functional block diagram of an exemplary implementation of a portion of the communication system shown in FIG. 1.

FIG. 3 illustrates a functional block diagram, similar to that shown in FIG. 2, but of another portion of the communication system shown in FIG. 1 pursuant to an implementation of the present disclosure.

FIG. 4 illustrates a functional block diagram, similar to those shown in FIGS. 2-3, but of another portion of the communication system shown in FIG. 1 pursuant to an implementation of the present disclosure.

FIG. 5 illustrates a message sequencing diagram representative of exemplary signaling generated pursuant to operation of an implementation of the present disclosure.

FIGS. 6-11 illustrate exemplary screen displays generated pursuant to operation of an implementation of the present disclosure.

FIG. 12 illustrates a functional block diagram of a communication system, similar to that shown in FIG. 1, in which an implementation of the present disclosure is implemented.

FIG. 13 illustrates a method flow diagram representative of the method of operation of an implementation of the present disclosure.

### DETAILED DESCRIPTION

The present disclosure, accordingly, advantageously provides an apparatus, and an associated method, by which to provide a buyer of a product, service, or other commerce with seller-submitted bids to sell the commerce item to the buyer.

Through operation of an implementation of the present disclosure, a manner is provided by which to provide for notification to prospective sellers of interest of a buyer to purchase a commerce item and to solicit and to receive bids from prospective sellers of the commerce item.

In one aspect of the present disclosure, a buyer posts the identity of a commerce item that the buyer desires to purchase. The posting constitutes a solicitation for bids from sellers that sell the commerce item. The posting of the identity of the commerce item and resultant solicitation for bids permit prospective sellers of the commerce item to submit bids to sell the commerce item. The bidders that submit bids to sell the commerce item effectively compete openly against one another to submit the bid that the prospective buyer selects.

In another aspect of the present disclosure, the prospective buyer posts the identity of the commerce item to a network server having functionality to cause the identity of the desired commerce item to be displayed, such as on a web page, accessible by way of the internet. Prospective sellers access the web page, or other display location. A prospective seller, if desiring to sell the commerce item, is thereby provided with notice of the desire of the buyer to purchase the commerce item. And, through such notification, the prospective seller is made aware of the interest of the buyer to make the purchase.

In another aspect of the present disclosure, responsive to the notification and a decision by the prospective seller to sell the commerce item to the buyer, the prospective seller submits a bid to sell the commerce item to the buyer. Through such submission, the prospective seller provides for the prospective buyer to be notified of the interest of the seller to sell the commerce item.

In another aspect of the present disclosure, the prospective buyer is made aware of each bid submitted by a prospective seller of the commerce item. In one implementation, a filter mechanism is utilized by which to filter bids submitted by prospective sellers of the commerce item by way of any filter criteria, such as filter criteria selected by the prospective buyer. Filter criteria includes, for instance, price, geographical, and differentiating features of commerce items offered for sale by a prospective seller. In another implementation, in addition to filtering, or in the alternative to filtering, the submitted bids are ordered according to an ordering criteria. The ordering criteria is also any desired criteria including, for instance, price, geographical location, etc.

In another aspect of the present disclosure, the prospective buyer is made aware of the submitted bids by way of messages, or other information, pushed to a device, such as a computer workstation, utilized by the prospective buyer, or through access by the prospective buyer to a network server or other location, at which the prospective-seller-submitted bids are received. The prospective buyer is thereby able to consider the competing bids and to make selection therefrom.

In another aspect of the present disclosure, the buyer selects from amongst the competing bids, or elects not to accept any of the bids. Selection is made by the prospective buyer, and the selection is provided to the network server, or other location, to provide the indication of the selection made by the prospective buyer. The selection by the buyer forms an acceptance of the bid made by the prospective seller whose offer is selected by the prospective buyer. And, the network server, or other device provides an indication of the received selection to the prospective seller with the winning bid. In one implementation, the prospective sellers having non-selected bids are also notified of the selection made by the prospective buyer.

In another aspect of the present disclosure, subsequent to submission by the prospective buyer of the commerce item that the prospective buyer desires to purchase, a time period commences during which prospective sellers are permitted to submit bids. The time period is either buyer-selected or selected by the operator of the network server or location, that provides the service. In one implementation, the bidding period is of an indeterminate period. That is, the period is not time-bound. Rather, the period terminates when the prospective buyer selects a bid or otherwise elects not to continue soliciting bids. In such an implementation, the prospective sellers of the commerce item continue to have opportunity to submit a bid until the prospective buyer makes selection of a bid. In another implementation, the bidding period is time-bound, e.g., a set period or a period chosen by the prospective buyer. In one implementation, the prospective seller can withdraw an offer to sell prior to closing of the bidding period, and the prospective buyer can withdraw an offer to purchase at anytime, even subsequent to the end of the bidding period.

In another aspect of the present disclosure, prospective sellers are able to view indications of bids submitted by other prospective sellers of the commerce item. Through such viewing of bids submitted by other prospective sellers, another prospective seller is able to make a determination of the bid that would be competitive with other bids that have already been submitted. Such a determination permits the other prospective seller better to select whether to submit a bid and, also, what the bid should include in order for the other prospective seller to make a bid that the prospective buyer would consider to be competitive.

In another aspect of the present disclosure, during at least a portion of the period within which prospective sellers are permitted to submit bids to sell the desired commerce item, a prospective seller who has already submitted a bid is able to update the submitted bid. That is to say, the prospective seller is permitted to make changes to the bid that was previously submitted. If, for instance, the prospective seller determines that the previously-submitted bid is not competitive, the prospective seller is able to submit a more-competitive bid. In one implementation, the prospective buyer is further permitted to modify the description, or conditions associated with, the commerce item that the prospective buyer desires to purchase. Such modification may, in turn, necessitate that the prospective sellers modify previously-submitted bids. The ability of a prospective seller to modify the bid, at least responsive to a modification submitted by the prospective buyer, better permits the offers for sale of the commerce item to match the commerce item desired for purchase by the prospective buyer.

In another aspect of the present disclosure, the prospective purchaser, when submitting, or otherwise providing, the information related to the commerce item desired to be purchased, includes identifying information as well as any additional conditions associated with a purchase of the commerce item. Conditions include, for instance, a time constraint, such as a required delivery date or performance date of the commerce item a geographical limitation associated with the commerce item, e.g., a limitation of an area within which, or beyond which, the prospective buyer is willing to accept delivery or performance of the commerce item, and permitted, or prohibited, variations of the commerce item that the prospective buyer is willing to consider, or is unwilling to consider, in the purchase deliberations and selection.

Thereby, by providing notification of the interest of the prospective buyer and the capability provided to prospective sellers of the interest of the prospective buyer, an improved bidding system is provided. The prospective buyer, through the posting of the information related to the commerce item, is able to receive bids from prospective sellers without individually querying the prospective sellers. And, the prospective sellers are made aware of the interest of the prospective buyer even when the prospective seller is not located close to the prospective buyer or otherwise would not likely be aware of the interest of the prospective buyer.

In another aspect of the present disclosure, the commerce item is any good or service amenable to purchase by a buyer of goods or services. In one implementation, the commerce item comprises a position solicited by the buyer. The solicited position comprises, for instance, an employment position or a school position. When the position comprises an employment position, the prospective buyer solicits a position of employment, and a prospective seller is a prospective employer or other entity that offer positions of employment. When the position comprises a school position, the prospective buyer solicits a position at a school, and the prospective buyer is a prospective student of the school or other educational facility. The prospective seller is a school or other educational facility that offers positions in the associated school or educational facility. The school position is, e.g., matriculation into an educational program being solicited by a prospective student who solicits issuance of an offer by a school acceptance into the educational program. An educational program is any type of academic, athletic, military, or other program in which instruction is provided.

In these and other aspects, therefore, an apparatus, and an associated method, facilitates purchase of a commerce item. Identification of the commerce item desired for purchase by a buyer is posted. Bids submitted by any of a plurality of sellers for sale of the commerce item are detected. And, provision is made for buyer acceptance of any bid submitted by any of the plurality of sellers.

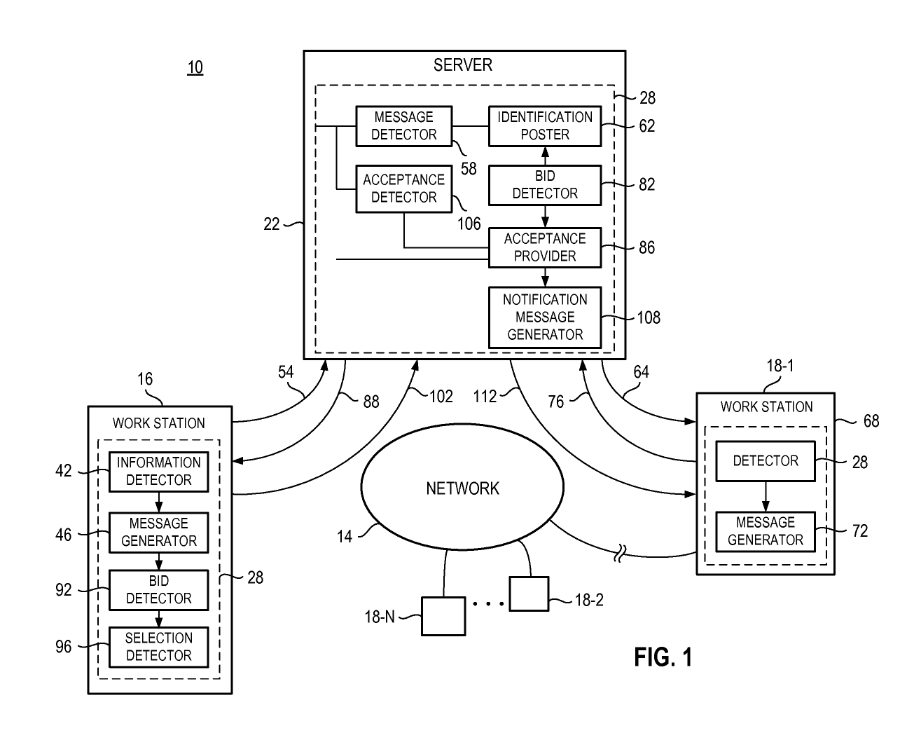

Referring first, therefore, to FIG. 1, a communication system, shown generally at 10, provides for communications between communication stations when connected in communication connectivity in the communication system. The communication system 10 includes a network 14, which is representative of any type of the communication backbone or fabric. In the exemplary implementation, the network 14 comprises the internet through which data is communicated in conventional manner.

In the exemplary communication system, communication stations are represented by computer stations 16, 18-1 through 18-N and an application server 22. The communication stations 16-22 are connectable, either by wired connections or wireless connection to the network 14 to provide for communications between the respective communication stations. Data is communicated during operation of the communication system 10 using, e.g., IEEE 802.11-formatted data. For purposes of description of an exemplary implementation of the present disclosure, the computer workstation 16 forms a buyer workstation, i.e., a workstation operated by a prospective buyer of a commerce item. The communication stations 16 and 18, for purposes of describing an exemplary implementation, shall be referred to as workstations 16 and 18. The workstations 18 are here representative of prospective seller workstations, that is to say, workstations operated by prospective sellers of a commerce item. And, the application server 22 is representative of a computer server having a processor configured to operate pursuant to an implementation of the present disclosure to facilitate collection of bids submitted by prospective sellers for a commerce item desired by a prospective buyer. The computer workstations 16 and 18 also include a processor or processing circuitry that performs processing operations pursuant to this procedure to provide a prospective buyer operating the workstation 16 with bids submitted by prospective sellers operating workstations 18.

The communication system includes apparatus 28 embodied at the network server 22, at the buyer workstation 16, and at the seller workstations 18. The apparatus 28 operates pursuant to an implementation of the present disclosure by which to provide bids to a prospective buyer of a commerce item to permit the prospective buyer to select from amongst competing bids submitted by prospective sellers of the commerce item. Because the prospective sellers are located at any location permitting connectivity to the network 14, a prospective seller need not be positioned in geographic proximity to the prospective buyer. A bid can be submitted by a prospective seller from any location by way of a workstation 18 that is connected to the network 14 in communication connectivity therewith. And, because the prospective buyer solicits bids for sale of the commerce item, the prospective sellers compete with one another to provide a bid that the prospective buyer selects.

In the exemplary implementation, operation of the system by which to obtain bids for the commerce item desired to be purchased by the prospective buyer is initiated at the buyer workstation 16. The prospective buyer enters information by way of a user interface (not separately shown) of the workstation to identify the commerce item that the prospective buyer desires to purchase. The commerce item is any item amenable to a commercial transaction, either a product or a service, that the prospective buyer can utilize or purchase on behalf of the user by another. The input information is detected by an information detector 42 that forms part of the apparatus 28 implemented at the communication station 16. The information detector 42 is functionally represented and, along with other elements of the apparatus 28, is implementable in any desired manner, including program code executable by processing circuitry.

Indications of the detected information are provided by the detector 42 to a message generator 46. The message generator functions to generate a message that includes the indications of the detected message. If, for instance, the prospective buyer desires to purchase a new automobile, the entered information pertains to the type of automobile and specific characteristics of the desired automobile. The entered information is detected by the detector 42 and provided to the message generator 46. The message generator generates a message that is formatted in a desired format and includes information pertaining to the automobile type and characteristics of the automobile type desired by the prospective buyer. The message generator causes generation and transmission of the message, indicated by the segment 54, for routing through the network 14 and delivery to the apparatus 28 embodied at the application server 22. The apparatus 28 implemented at the server 22 is also, in the exemplary implementation, implemented by a processor that executes program code to carry out the functions of the apparatus.

The message generated and transmitted by the workstation 16 is detected by a message detector 58. Indications of the detected message are provided to an identification poster 62. The poster 62 causes information associated with the detected message, i.e., the commerce item desired to be purchased by the prospective buyer, to be made available, at least for viewing, by the prospective sellers. In the exemplary implementation, the poster 62 causes generation of a webpage that includes the identification of the commerce item and, if desired, information associated with the prospective buyer. In one implementation, the generated webpage is a publicly-available webpage. In another implementation, the webpage, or the information-containing portion thereof, is available for viewing by a limited audience, such as pursuant to a subscription agreement.

Posted indications are viewable by others, such prospective sellers at the workstations 18. The segment 64 represents information, such as a message that provides for display of the webpage, at the workstation 18. A prospective seller that views the posted information is, through such viewing, notified of the desire of the prospective buyer to purchase the commerce item.

A prospective seller that elects to offer the commerce item for sale causes generation of an input by way of a user interface embodied at a workstation 18 that is detected by a detector 68 of the apparatus 28 implemented at a workstation 18. In the exemplary implementation, the apparatus 28 embodied at a workstation 18 comprises a processor or processing circuitry that executes program code to carryout operations pursuant to the present disclosure. In other implementations, the apparatus 28 is implemented in other manners.

The input includes information associated with the bid by the seller, including, for instance, identification of the commerce item that is posted, and additional details associated with the bid of the seller, such as variations to the commerce item, date of availability, and geographical location of the product or service constituting the commerce item. Indications of the detection made by the detector 68 are provided to a message generator 72. The message generator 72 functions to cause generation and transmission of a message that contains indications of the bid entered by the prospective seller. In the illustration of FIG. 1, the bid is entered by a prospective seller positioned at the workstation 18-1, and the message generated by the generator 72 and is routed, indicated by the segment 76, to the network 14 and delivered to the application server 22. The message, once delivered to the server 22 is detected by a bid detector 82 of the apparatus 28 implemented at the server. In the exemplary implementation, indications of the detected bid are provided to the poster 62 that also functions to post indications of the information contained in the bid.

In the exemplary implementation, indications are also provided to an acceptance provider 86 that functions to cause generation and routing of a message, indicated by the segment 88, for delivery to the workstation 16 of the prospective buyer. The message is detected by a detector 92 embodied at that apparatus 28 of the workstation 16. The submission of the bid by the prospective seller is then provided, such as by way of a user interface, to the prospective buyer. In one implementation, alternately, or additionally, the posting of the detected bid at the server 22 is available for viewing by the prospective buyer to notify the prospective buyer thereby of the submitted bid. Bids submitted by other prospective sellers at other workstations 18 are analogously submitted, and notifications are analogously provided to the buyer of the bid entered by the prospective seller operating the workstation 18-1.

When multiple bids are submitted and provided to the prospective buyer, the prospective buyer is able to make selection from amongst the competing bids. In one implementation, during a period, a prospective seller is able to update a previously-submitted bid. For instance, for a time-constrained period, a prospective seller is permitted to update the previously-submitted bid. Or in one implementation, the period is event-constrained, such as by the prospective buyer closing the biding or selection by the prospective buyer to accept one of the bids, or to reject all of the bids.

The apparatus 28 embodied at the workstation 16 also includes a selection detector 96 that detects entry of selection by the prospective buyer of the commerce item. Buyer selection is entered, e.g., by way of a user interface of the workstation 16, and such entry is detected by the detector 96. Indications of the detector are provided to the message generator 46, and the message generator generates and causes transmission, indicated by the segment 102, of a message that identifies the selected bid. The message is delivered to the server 22 and detected by an acceptance detector 106 of the apparatus 28 embodied at the server. Indications of the detected message are provided to the acceptance provider 86 that, in turn, provides indications to a message generator 108 that causes generation and transmission, indicated by the segment 112, to the workstation associated with the selected bid. Here, for purposes of example, the bid submitted by the prospective seller at the workstation 18-1 is the selected bid, and the prospective seller is notified of the selection. The detector 68 is further operable to detect the message identifying the selection of the submitted bid to sell the commerce item.

Thereby, a prospective buyer of a commerce item is able to solicit bids to sell the commerce item without necessitating the prospective buyer contacting prospective sellers of the commerce item. A greater number of prospective sellers are likely to be available to submit bids to sell the commerce item than the number that would be available if the buyer were required to contact each prospective seller known to the buyer. Additionally, because the prospective sellers are able to view the bids submitted by others of the prospective sellers, the prospective sellers compete against each other to submit the bid that shall be selected by the prospective buyer.

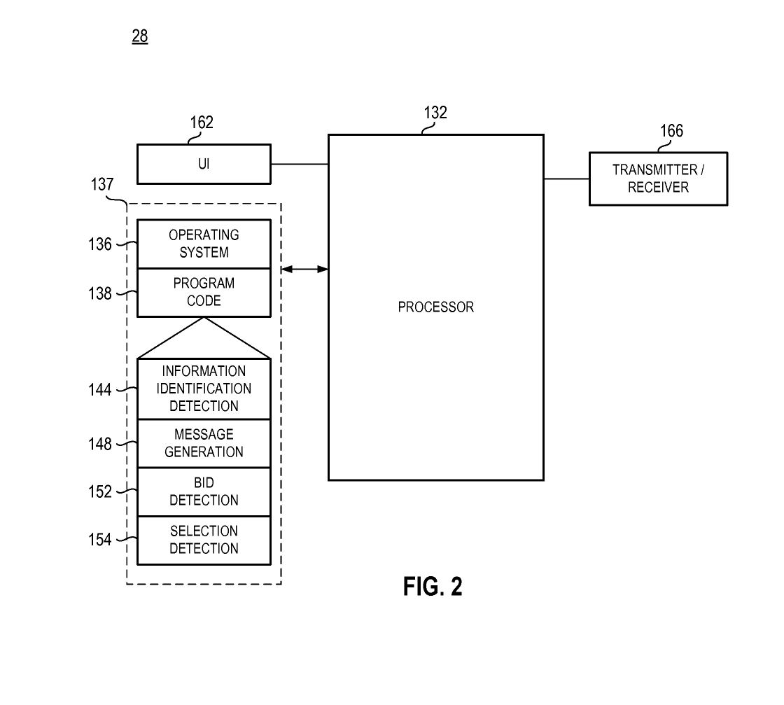

FIG. 2 illustrates a representation of an exemplary implementation of the apparatus 28 embodied at the workstation 16 operated by a prospective buyer. The apparatus includes a processor 132 that is configured to perform processing functions. In the exemplary implementation, the processor 132 forms the main processor of the workstation 16 or works in conjunction therewith. In operation, the processor invokes program code forming the operating system, indicated by the block 136. The program code is stored, for instance at a memory 137 whose contents are accessible by processor.

Additional program code, indicated by the block 138, is maintained at the memory and invoked by the processor 32 during operation of an implementation of the present disclosure. The program code 138 is formed of modules that are invoked by the processor, and the instructions of the program code are carried out by the processor to perform the functions of the respective modules. The modules here include modules 144, 148, 152, and 154.

The module 144 comprises an information identification detection module that, when invoked, detects identification information associated with prospective-buyer-entered information entered information by way of a user interface, here indicated at the block 162. Information related to a consumer item, a product or a service, desired to be purchased by a prospective buyer, is identified and detected during operation of the module 144.

The message generation module 148, when invoked, forms a message that is formatted to include indications of the identification information detected during operation of the module 144. Once generated, the message is caused to be transmitted by the transmitter/receiver 166.

The detection module 152 operates to detect delivery, such as by way of the transmitter/receiver 166, of a bid to sell the commerce item. The bid identifies, for instance, the commerce item, specifics of the commerce item, including variations to the description of the commerce item delivery dates, geographical information, and any other pertinent information.

The selection detection module 154 is invoked by the processor 132 and the detects entry, such as by way of the user interface 162, of selection to accept, or to reject, or otherwise to take action with respect to, a bid to sale a commerce item by a prospective seller of the commerce item. The entered information is, if appropriate, formatted into a message, through invocation of the message generation module 148 and transmitted elsewhere, as appropriate.

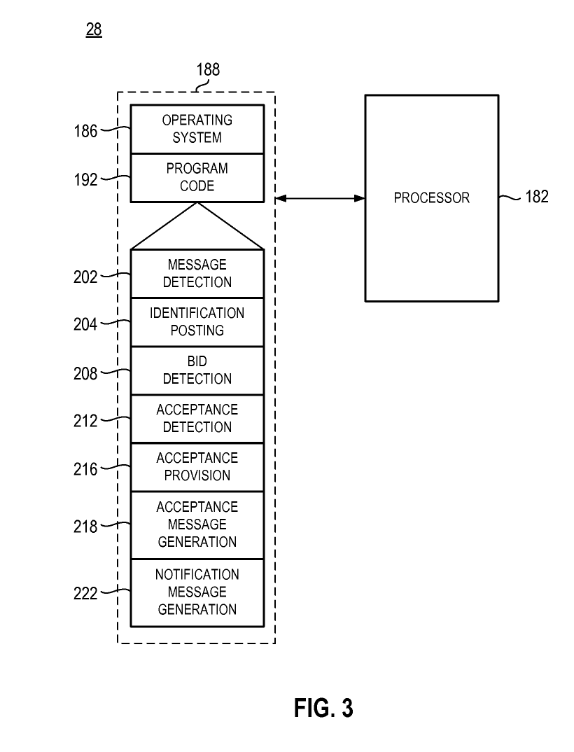

FIG. 3 illustrates a representation of an exemplary implementation of the apparatus 28 embodied at the application server, or other device, 22. The apparatus includes a processor 182 that is configured to perform processing functions, including processing functions pursuant to operation of an implementation of the present disclosure. In the exemplary implementation, the processor 182 forms the main processor of the server, or other device, 22 or is configured to be operable in conjunction therewith.

In operation, the processor 182 invokes program code forming the operating system, indicated by the block 186. The program code is stored, for instance, at a memory 188, whose contents are accessible by the processor 182.

Additional program code, indicated by the block 192, is also maintained at the memory 192 and is invoked by the processor 182 during operation of an implementation of the present disclosure. The program code 192 is formed of modules that are invoked by the processor, and the instructions of the program code of the respective modules are carried out by the processor to perform the functions of the respective modules.

The modules include a message detection module 202 that is invoked to detect delivery of a message that identifies a prospective buyer and a commerce item that the prospective buyer desires to purchase. An identification generation posting module 204 is invoked to cause posting, at a webpage, information associated with the detected message. The information that is posted includes, for instance, identification of the commerce item and, if desired, identification of the prospective buyer. Details associated with the commerce item are also posted, if desired.

The program code also includes a bid detection module 208. The bid detection module is invoked to detect messages delivered by prospective sellers of a posted commerce item. The detected message includes, for instance, an identification of the commerce item and any details associated with the submitted offer to sell, including, for instance, variances with the posted or listed commerce item. The program code further includes an acceptance detection 212 that is configured to detect a message delivered from the prospective buyer that accepts, or is otherwise associated with, a submitted bid, submitted by a prospective seller of the commerce item.

The program code includes an acceptance providing module 216 that is invoked to provide indications of a detected bid to a prospective buyer and is invoked when detection is made of an acceptance message provided by the prospective buyer. The program code further includes an acceptance message generation module 218 that is invoked to cause generation of an acceptance message and a notification message generation module 222 that is invoked to cause creation of a message to notify a prospective seller of the commerce item of acceptance or other communication associated with, the prospective buyer of the commerce item with the bids submitted by the prospective seller. In one implementation, subsequent prospective buyer acceptance of a particular bid submitted by a particular, prospective seller, the notification message generation module is further invoked in order to notify non-selected, prospective sellers of the sellers of the selection by the buyer.

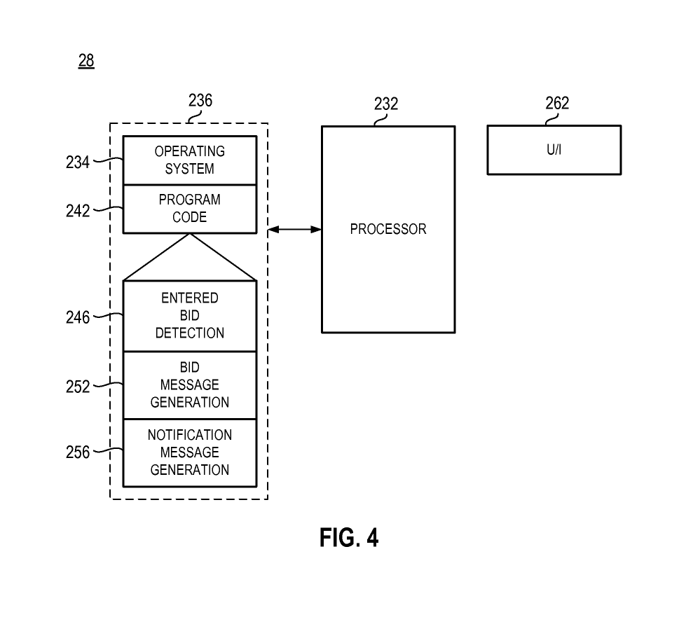

FIG. 4 illustrates a representation of an exemplary implementation of the apparatus 28 embodied at a computer workstation operated by a prospective seller. The apparatus includes a processor 232 that is configured to perform processing functions. In the exemplary implementation, the processor 232 forms the main processor of the workstation 18 or works in conjunction with the processor of the workstation. In operation, the processor 232 invokes program code forming an operating system of the workstation. The program code forming the operating system is indicated by the block 234 and is stored at a memory 236. The contents of the memory 236 are accessible by the processor 232 during operation of the processor.

Additional program code, indicated by the block 242, is also maintained at the memory 236. The additional program code is invoked by the processor 232 during operation of an implementation of the present disclosure. The program code 242 is formed of modules that are invoked by the processor, and the instructions of the program code are carried out by the processor to perform the functions of the respective modules. The modules here include an entered bid detection module 246, a bid message generation module 252, and a notification message detection module 256.

In operation, a prospective seller operating a workstation 18 is able to view postings of commerce items desired to be purchased by a prospective buyer by viewing postings on a webpage, such as a webpage produced by the network server 22 (shown in FIG. 1). Viewing of the webpage is carried out in conventional manner, such as by way of viewing of the webpage at a user interface 262. In one implementation, the prospective seller is alerted, such as by way of a push message, email, or other notification, when a prospective buyer causes posting of a commerce item for which a prospective seller is likely to have interest in placing a bid for the sale of the commerce item.

If the prospective seller selects to submit a bid to sell the commerce item, the prospective seller enters information relating to the offer by way of the user interface 262. The entered bid detection module 246 is invoked to detect the entered information. Then, the bid message generation module is invoked to cause generation of a message to convey the bid for consideration by the prospective buyer. In the exemplary implementation, the bid is communicated to the server 22 or other device from which the information associated with the prospective buyer of the commerce item is associated.

If, or when, a response is made to the entered bid, the notification message detection module 256 is invoked to detect the response, which provides notification to the prospective seller of action taken with respect to the bid. Indications of the notification are provided to the prospective seller by way of the user interface 262.

As noted previously, in one implementation, a prospective seller is permitted to make changes to a previously-submitted bid within a bidding period, either a bidding period defined in terms of time or action, determined by the prospective seller or as a result of a system parameter. Invocation of the modules 246-256 is undertaken, as needed, to provide for the updating of the prospective seller.

In exemplary operation, a plurality of prospective sellers, operating workstations 18, submit a plurality of bids, providing the prospective buyer with a plurality of offers from which selection can be made. A prospective buyer makes selection based upon any desired criteria, including price, time-of-delivery, location of delivery, etc. Because the prospective buyer is provided with a plurality of bids submitted by a plurality of prospective sellers that view a posting of the prospective buyer's desire to purchase the commerce, the prospective sellers compete amongst themselves for the purchase by the buyer without requiring significant effort to be undertaken on the part of the prospective buyer.

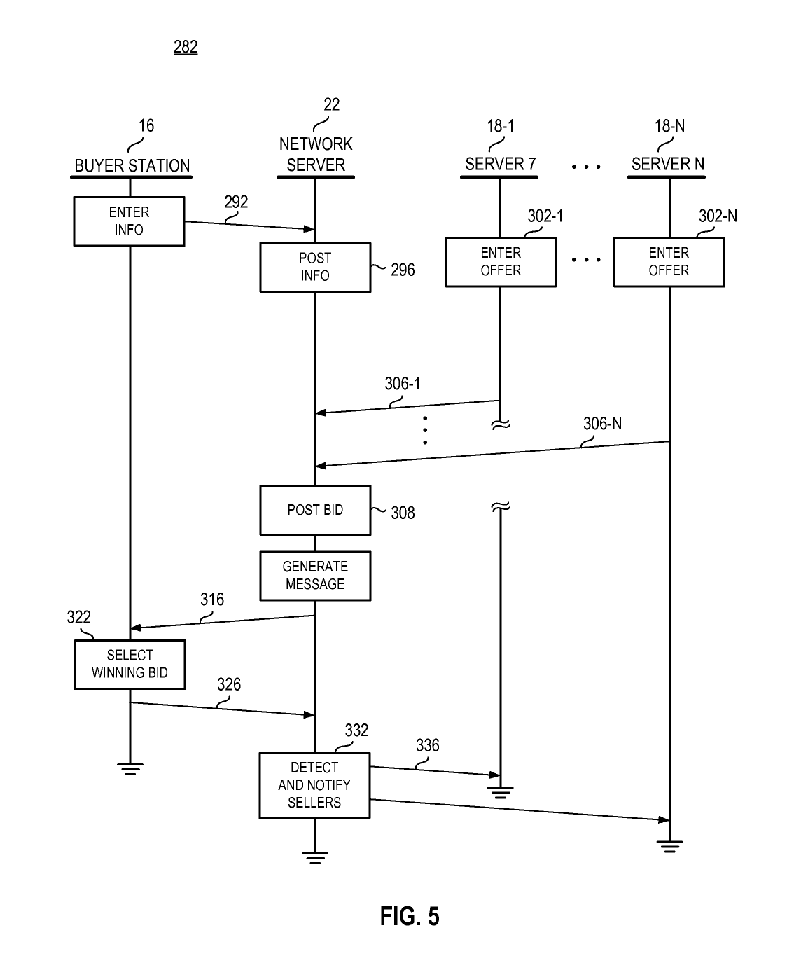

FIG. 5 illustrates a message sequence diagram 282 representative of exemplary operation of the communication system 10 pursuant to operation of an implementation of the present disclosure. Exemplary signaling between buyer and seller workstations 16 and 18 and a network or application server 22 is shown in the Figure.

In the exemplary implementation, the prospective buyers and sellers are registered with the server application that operates pursuant to an implementation of the present disclosure. The registration is carried out in conventional manner to identify the parties, i.e., the prospective buyers and sellers. The server application at the server 22 maintains a history of the registrants and, e.g., determines the status, e.g., indications of their respective credit worthiness or sales-history of the respective registrants. The status of a party indicates to another party the capability, based upon past performance, of another party to complete a transaction for the purchaser sale of a commerce item.

Subsequent to registration, and as indicated at the block 286, a prospective buyer at the workstation 16 enters information regarding a commerce item that the prospective buyer desires to purchase. The information is detected, and a message is generated and transmitted, indicated by the segment 292, that is routed through a communication network, such as the network 14 shown in FIG. 1, for delivery to the server 22. An application at the server 22 detects the message, extracts the informational content of the message, and posts, indicated by the block 296, the information on a webpage, that is available for viewing, at least by registered parties, such as prospective sellers that operate the workstation 18-1 through 18-N. In one implementation, the posts are available for viewing by anyone accessing the webpage; in another implementation, only registered users of the application service are permitted to view the contents of the webpage. And, in one implementation, the application at the server 22 notifies prospective sellers, such as by way of an email or push message, of the interest of the prospective seller to purchase the commerce item. Notification, in this implementation, is provided to prospective sellers that register their interest to sell a commerce item similar to the posted commerce item. Information that permits generation at a workstation of a webpage display comprises sending messages to the workstation and are here subsumed in the block 296.

Once a prospective seller becomes aware of the interest of the prospective purchaser to purchase the commerce item, a prospective seller is able to submit a bid, constituting an offer to sell the commerce item. Here, all of the prospective sellers 18-1 through 18-N enter offers, indicated by the blocks 302-1 through 302-N. The offers are detected, and information associated with the entered bids is extracted, and messages are formed and sent, indicated by the segments 306-1 through 306-N. The message is routed to the application at the server 22.

When received at the application embodied at the server 22, the informational content of the messages is extracted, and the information is posted, indicated by the block 308, of the webpage for viewing by the prospective buyer and also the prospective sellers. In the exemplary implementation, a message is generated, indicated by the block 312, and sent, indicated by the segment 316, to the buyer to alert the buyer to the submitted offer or offers. In one implementation, a separate message is generated for each submitted offer. And, in one implementation, the information needed to generate at a workstation a webpage display with the bid information is subsumed in the block 308.

In one implementation, the prospective sellers are permitted to amend or update their bid during a period, either a time-constrained period or an event-constrained period. A prospective seller is able, upon viewing competing bids, to submit an updated, more-competitive bid. Steps analogous to those of steps 302 and message generation analogous to messages 306 are carried out, generated, and sent pursuant to the updating procedure.

When multiple offers to sell the commerce item are submitted, the prospective buyer is permitted to select from amongst the competing offers. Selection is evidenced by entry of an indication of the selection, indicated at the block 322. Information associated with the selection is detected, and a message is generated and sent, indicated by the segment 326. The message is routed to the application at server 22. The informational content of the message is detected, indicated by block 332, and a notification message is generated and sent, indicated by the segments 336, to the prospective sellers. In the exemplary implementation, each of the prospective sellers is notified, either of acceptance of the bid by the prospective seller or non-selection of the bid. In another implementation, only the winning, prospective seller is notified of the selection by the prospective buyer. Subsequent communications are effectuated between the prospective buyer and seller, either directly or by way of the application embodied at the server 22.

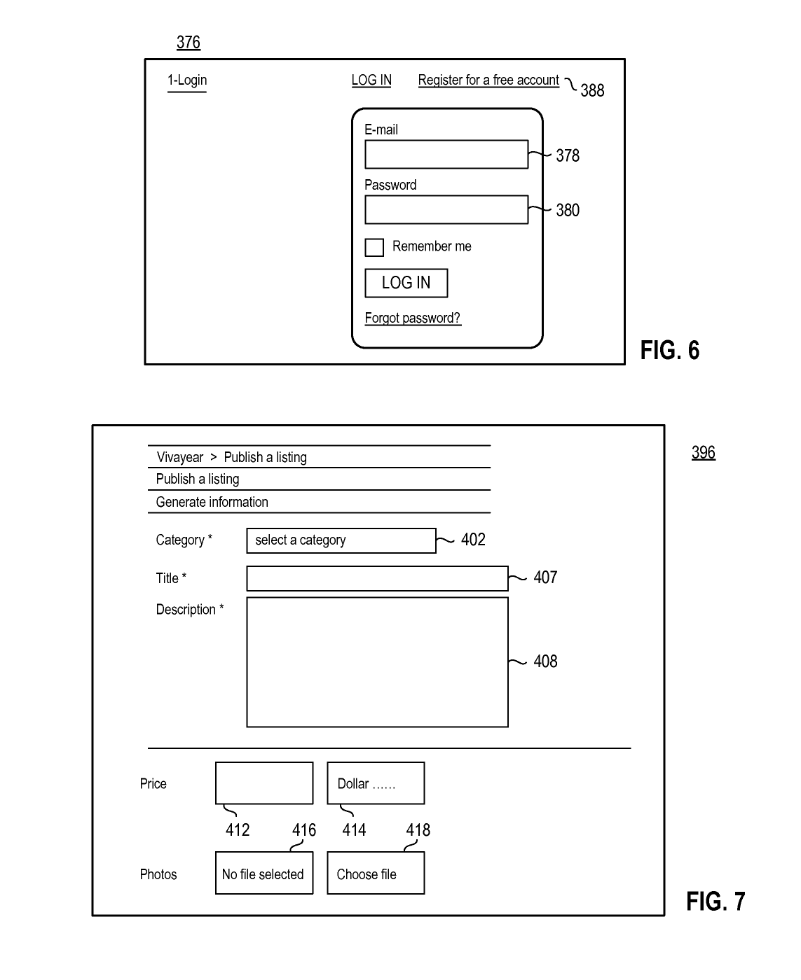

FIG. 6 illustrates an exemplary screen display generated during operation of an implementation of the present disclosure. The screen display is generated for display at, e.g., the workstation 16 operated by a prospective buyer. The screen display forms a log-in display that is utilized by a prospective buyer to log-in to the system of the present disclosure that provides for the solicitation of bids to sell a commerce item that the prospective buyer desires to purchase. The display 376 is generated in the exemplary implementation by the prospective buyer accessing the page provided by an operator of the application at the application server 22 (shown in FIG. 1). In an alternate implementation, the display 376 is generated by a local application resident at the workstation 16.

The log-in display page here provides for the log-in of a registered user of the system. Here, the registered user is identified by e-mail address associated with the user. Log-in is carried out through entry of the email address at the block 378 and a password at the block 380. Log-in is initiated through actuation of the log-in key 384. The display 376 also provides for registration for a new user by way selection of the length 388. Registration is carried out in any conventional manner.

In the exemplary implementation, log-in of a prospective seller is carried out in a similar manner by way of the display 376 or a similar display.

FIG. 7 illustrates a screen display 396 that is also generated pursuant to operation of an implementation of the present disclosure. The display 396 is generated when a prospective buyer elects to solicit bids for the purchase of a commerce item. Identification of the commerce together with information associated with the commerce item forms a listing, and the display 396 provides for publishing of the listing. The display 396 is displayed subsequent to log-in. In one implementation, an intermediary display (not shown) provides for selection to cause the display of the display 396. The display 396 contains blocks 402, 404, 408, 412, 414, 416, and 418.

The block 402 provides for a drop-down menu of designated categories of commerce items. A prospective buyers selects from the menu. Then, the prospective buyer enters a title of the commerce item at the block 404 and a description of the commerce item at the block 408. A maximum price that the prospective buyer shall consider is entered, if desired, at the blocks 412 and 414. Blocks 416 and 418 are selected in the event that a photographic, or other, file is to be included in the listing. The prospective buyer then causes the entered information to be communicated to the application at the application server 22 (shown in FIG. 1).

In the exemplary implementation, the display 396, or a similar display, is provided to a prospective seller of a commerce. The prospective seller causes publication of a listing of the commerce item that the prospective seller offers for sale in response to the listing published by the prospective buyer. Analogous types of information are entered at the display, and the entered information is caused to be provided to the application at the application server 22.

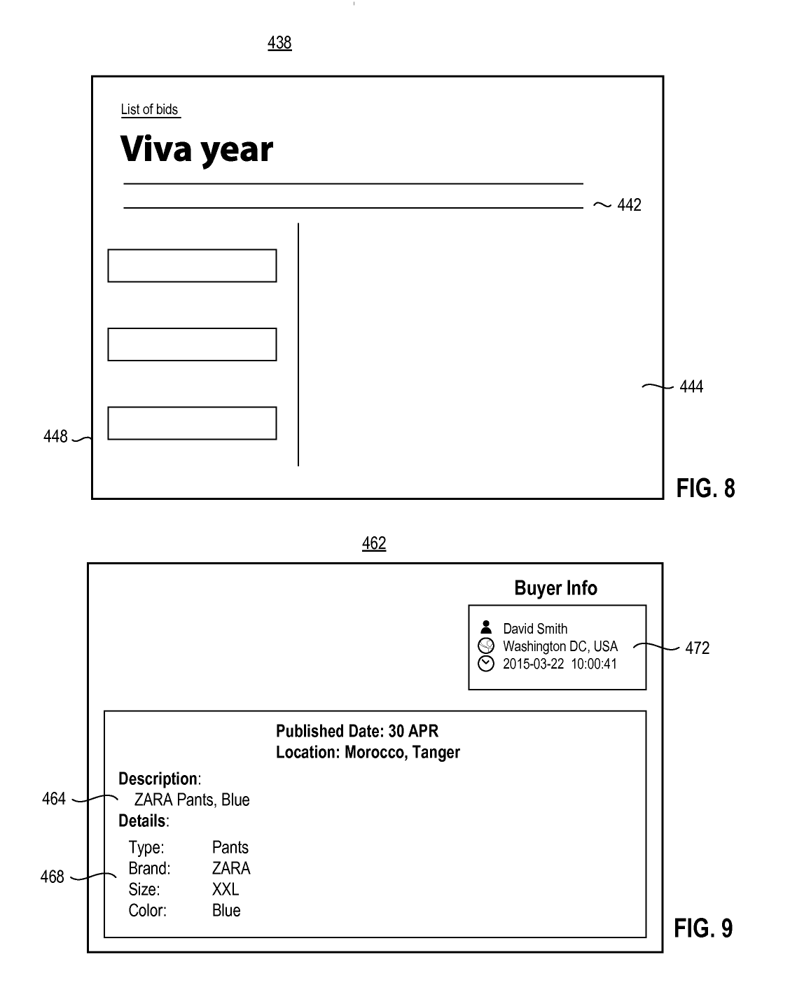

FIG. 8 illustrates an exemplary screen display 438 generated pursuant to further operation of an implementation of the present disclosure. The screen display 438 is generated, e.g., at an application server 22 and forms a webpage available for viewing by a prospective buyer or a prospective seller at a workstation 16 or 18. The webpage is accessible in conventional manner, available, for instance, by registered users of the application that forms an implementation of the present disclosure. The display 438 includes an exemplary listing 442 comprised of a plurality of entries 444. Each entry of the listing includes information associated with a commerce item that is desired to be purchased by a prospective buyer. The listing 442 is an exemplary listing that is categorized in a particular category, here in which the mode is a woman 446. Information associated with each entry identifies the commerce item, the number of bids associated with the commerce item, the current bid price, location, and date of entry. Other listings, analogous to the listing 442, are also creatable by a user of the system through appropriate entry of information, here at the left-hand side of the display that provides for entry of search terms, the specifics of which define the listing and the contents thereof. The selection criteria define filter terms that filter data that results in the formation of the listing.

FIG. 9 illustrates an exemplary screen display that also is generated pursuant to operation of an implementation of the present disclosure. The display 462 is an expanded view of an entry 444 of the listing 442 shown in FIG. 7. The display 462 is selected, for instance, by a prospective seller from the listing 442. When displayed, the prospective seller, or other party is provided with additional information associated with the commerce item that a prospective buyer desires to purchase. With the additional information a prospective seller is able to select whether to submit a bid for the sale of the commerce item. The screen display identifies the commerce item by a description 464, with details 468 associated with the commerce item, and details 472 of the prospective buyer of the commerce item.

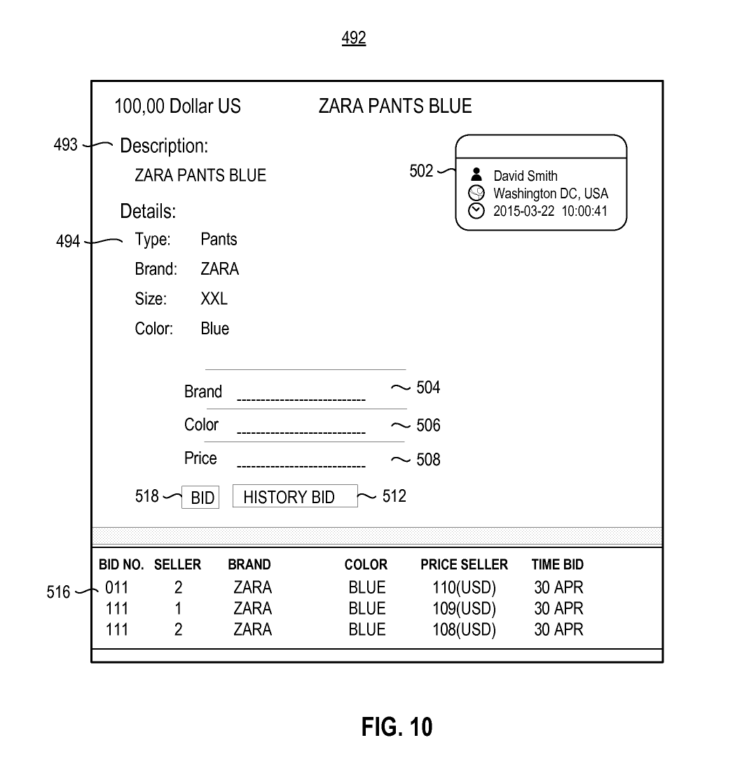

FIG. 10 illustrates a screen display 492 that is generated when a prospective seller elects to submit a bid to sell a commerce item. Here, by way of example, the commerce item comprises the commerce item displayed in the screen display 462, shown in FIG. 8. Analogous to the information displayed in the screen display 462, the screen display 492 also displays a description 492 of the commerce item and details 494 associated with the commerce item. Information 502 associated with the prospective buyer is also displayed.

The display 492 further includes boxes 504,506, and 508 that provide for entry by the prospective seller of information associated with a commerce item that the prospective seller shall submit as an offer to sell in response to the solicitation for bids entered by the prospect buyer and identified in the screen display 438 and 462. The specifics of the boxes 504, 506, and 508, and any additional boxes that are utilized in other implementations, are dependent upon the category of the commerce item. For other commerce items, greater, or fewer, number of boxes, associated with other characteristics of the commerce item are utilized. The display 492 further includes a history bid selection icon 512 that, if selected, provides for the display of the listing 516 of other bids submitted to sell the identified commerce item. In the exemplary display, three other bids have been submitted. When the appropriate information has been entered, the prospective seller submits the information by selection of the bid icon 518.

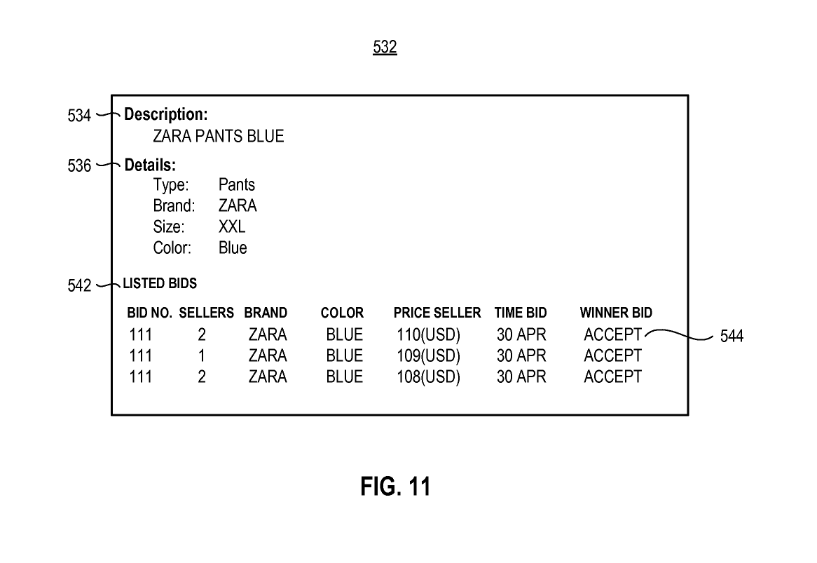

FIG. 11 illustrates a screen display 532 that is provided to the prospective buyer of the commerce item. The screen displays includes a description 534 and details 536 associated with the commerce item. Additionally, a listing 542 is provided that lists the bids that have been submitted in response to the solicitation for bids. Here, three bids are listed. The prospective buyer is able to select amongst the bids through selection of an accept key 544.

Thereby, a prospective buyer of a commerce item is provided with bids submitted by prospective sellers of the commerce item. The prospective sellers of the commerce item compete amongst each other to submit the bid that is selected by the prospective buyer. And, because the solicitation of the bids is made known, by way of the internet or other network, the geographical scope of prospective bids is not limited by geographical proximity to the prospective buyer.

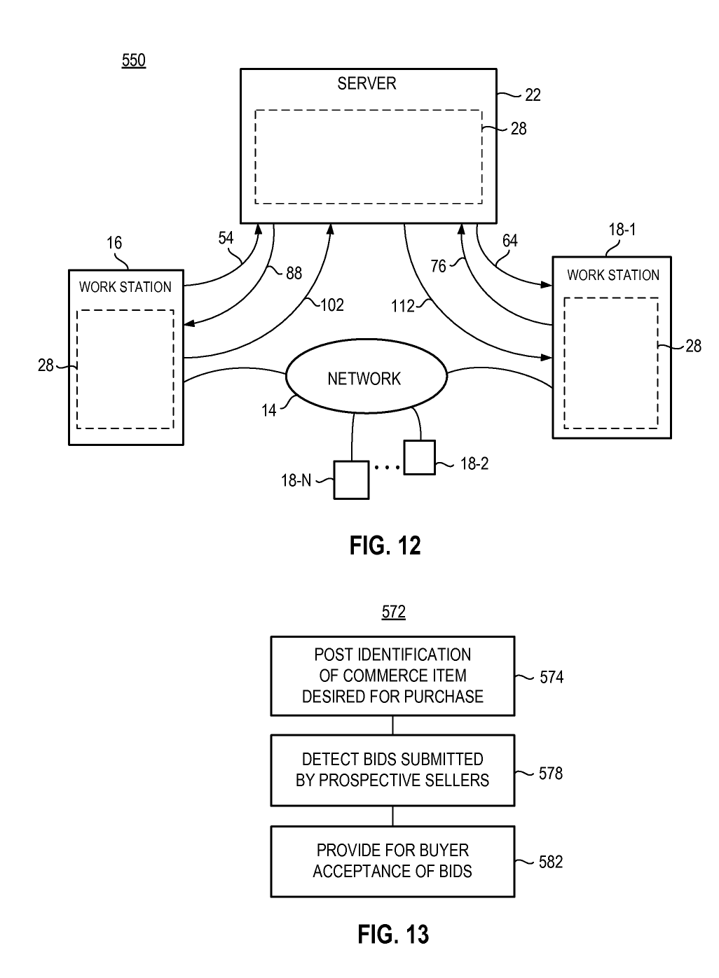

FIG. 12 illustrates a functional block diagram of an implementation of the present disclosure in which the commerce item for which the potential buyer solicits bids is a position in a school of an educational institution. The potential buyer here is a prospective student, or one acting on behalf of the student, who solicits acceptance into a school program of the educational institution. The prospective sellers are the educational institutions, or their agents or admission committees, that offer admissions to students to matriculate into the institutions.

FIG. 12 illustrates a communication system 550, which includes elements that are commonly-referenced to those illustrated in FIG. 1. The network 14 again provides for communication connectivity with workstations 16 and 18 and with a server 22. The workstation 16 forms a workstation of a prospective student, and the workstations 18-1, 18-2, . . . 18-N comprise workstations of different schools or other educational institutions. The workstations 16 and 18 and the application server 22 each include the apparatus 28. Operation is described with respect to the prior Figures.

In this implementation, the prospective student enters or otherwise provides input information that identifies the type of academic position or curriculum that the student solicits. The commerce item therefore forms admission to the desired educational institution or school. A message containing the information is generated and forwarded, indicated by the segment 54, to the server 22 whereat the message is detected and the information contained therein is posted. The information is made available for inspection and review by personnel at the educational institutions by way of information provided, indicated by the segment 64, to the workstations 18. Information input by the student, and thereafter available for inspection and review, includes, any information that would provide a basis for an educational institution to enter a bid, i.e., offer an admission to the institution. In the exemplary implementation, information relating to the background of the student, the test scores of the student, grades of the student, extracurricular activities of the student, and other appropriate information. In one implementation, the information input at the workstation 16 includes information conventionally contained in admission applications for admission to an educational institution.

Personnel of the educational institution, such as the admissions committee, review the provided information and elect whether to offer admission to the student. In this regard, the personnel act to submit bids to the student of offers for acceptance of the student into the associated school. A decision is made whether to accept the student, based upon the provided information. If the decision is affirmative, that is, the decision is a decision to accept the student, a message is generated and provided, indicated by way of the segment 76, to the server. The server, in turn, provides an indication, indicated by way of the segment 88, to the workstation 16. If multiple acceptances, that is, bids, are submitted by multiple schools, the student is able to select from amongst the acceptances, that is, bids submitted by the sellers formed of the schools associated with the workstation 18.

Responsive to an acceptance, the student makes selection by way of the workstation 16 to choose from amongst the acceptances, if more than one are submitted, or to choose a single acceptance, if one acceptance is submitted.

When multiple educational institutions monitor the postings of students that submit offers to accept positions at an institution, the educational institutions are able to elect whether to accept the prospective student from amongst all students that solicit bids, not merely the students that directly contact the educational institution. And, the prospective student is able to make the information of the student, and of the student's interest in soliciting bids for school admission, known to all educational institutions that access the server 22.

FIG. 13 illustrates a method flow diagram 572 representative of the method of operation of an implementation of the present disclosure. The method 572 facilitates purchase of a commerce item.

First, and as indicated by the block 574, identification of the commerce item desired for purchase by a buyer is posted. Then, and as indicated by the block 578, bids submitted by any of a plurality of sellers for sale of the commerce item is detected. Then, and as indicated by the block 582, provision is made for buyer acceptance of any of the detected bids.

Thereby, a manner is provided by which a prospective buyer solicits bids of offers to sell a commerce item. A site is provided for the prospective buyer to solicit the bids, and prospective sellers bid against each other on the site to provide the winning bid. The offers to sell the commerce item are transparently made. In the exemplary implementation, prospective sellers are able to see other bids that are submitted by other prospective sellers. The prospective buyer selects from amongst the available offers. Thereby, the prospective buyer need not take active steps to search for a best price for the commerce item. Rather, the prospective sellers compete against each other to provide the commerce item at the best price for the prospective buyer.

Presently preferred implementations of the disclosure and many of its improvements and advantages have been described with a degree of particularity. The description is of preferred examples of implementing the disclosure, and the description of examples is not necessarily intended to limit the scope of the disclosure. The scope of the disclosure is defined by the following claims.

What is claimed is:

1. A method for facilitating purchase of a commerce item by a buyer, said method comprising:
posting identification of the commerce item desired for purchase by the buyer;
detecting bids submitted by any of a plurality of sellers for sale of the commerce item posted during said posting; and
providing for buyer acceptance of any bid detected during said detecting.

2. The method of claim 1 wherein the commerce item comprises a service.

3. The method of claim 1 wherein the commerce item comprises a product.

4. The method of claim 1 wherein said posting comprises displaying the identification of the commerce item at a seller-accessible webpage.

5. The method of claim 1 wherein said detecting bids comprising detecting a bid containing a condition.

6. The method of claim 5 wherein the condition comprises a commerce-item differentiation that distinguishes the bid with the commerce item posted during said posting.

7. The method of claim 1 further comprising posting the bids detecting during said detecting the bids.

8. The method of claim 7 further providing for seller-modification of seller-submitted bids detected during said detecting the bids.

9. The method of claim 8 further comprising posting the seller-modification of the seller-submitted bids.

10. The method of claim 9 wherein said providing comprises providing for buyer acceptance of any of the bids detected during said detecting the bids, including bids having the seller-modification.

11. The method of claim 1 further comprising:
identifying bids submitted by sellers for sale of a commerce item desired for purchase by a buyer;
detecting buyer acceptance of a bid identified during said identifying; and
providing for notification of buyer acceptance of the bid.

12. The method of claim 11 wherein said identifying comprises identifying bids submitted responsive to buyer-posting of an identification of the commerce item desired for purchase by the buyer.

13. The method of claim 12 wherein the buyer-posting of the identification is posted on a webpage.

14. The method of claim 13 wherein the identifying the bid comprises identifying bids submitted responsive to the posting of the commerce item on the webpage.

15. The method of claim 11 wherein said providing for notification comprises generating a notification message for communication to seller associated with the accepted bid.

16. The method of claim 1 wherein the commerce item comprises admission to an educational institution, wherein said posting identification comprises posting identification of the admission to an educational institution desired for purchase, wherein said detecting comprises detecting bids forming admission offers submitted by any of a plurality of educational institutions, and wherein said providing comprises providing for acceptance of any admission offer detected during said detecting.

17. An apparatus for facilitating purchase of a commerce item, said apparatus comprising:
a processor configured to:
post identification of the commerce item desired for purchase by a buyer;
detect bids submitted by any of a plurality of sellers for sale of the commerce item; and
provide for buyer acceptance of any submitted bid.

18. The apparatus of claim 17 wherein the commerce item comprises admission to an educational institution, and wherein said processor is configured to:
post identification of the admission to an educational institution desired for purchase, detect bids, forming admission offers, submitted by any of a plurality of educational institutions, and to provide for acceptance of any submitted bid.

19. An apparatus for facilitating purchase of a commerce item, said apparatus comprising:
a processor configured to:
identify bids submitted by sellers for sale of a commerce item desired for buyer-purchase;
detect buyer acceptance of a submitted bid; and
provide for notification of buyer acceptance of the bid.

20. The apparatus of claim 19 wherein the commerce item comprises admission to an educational institution, and wherein said processor is configured to:
identify bids forming admission offers by educational institutions, detect student acceptance of an admission offer, and provide for notification of student acceptance of the admission offer.
